(19) United States
(12) Patent Application Publication
(10) Pub. No.: US 2008/0114647 A1
(43) Pub. Date: May 15, 2008

(54) Wireless system for coupon acquisition and redemption

(76) Inventors: Irek Singer, Mississauga (CA); Andrzej Rok, Mississauga (CA)

Correspondence Address: DAVID W. WONG, 46 WILLOWBROOK ROAD, THORNHILL, ON, L3T 4W9, omitted

(21) Appl. No.: 11/594,533

(22) Filed: Nov. 9, 2006

(51) Int. Cl. G06Q 30/00

(52) U.S. Cl. 705/14

(57) ABSTRACT

A paperless merchandise discount coupons acquisition and redemption system is provide by employing the consumer's cell phone or other wireless device. The consumer registers in the system with the unique IMEI number or Bluetooth(trademark) friendly address, and specifies products interested. The system matches the consumer's registered information and in response to purchase information of the consumer to provide the discount amount to the retailer from whom the consumer purchases the product.

### BACKGROUND OF THE INVENTION

1. Field of the Invention

This invention relates generally to the field of coupon acquisition and redemption by consumers and more particularly to discount coupons acquisition and redemption by consumers by utilizing wireless devices having short range wireless radio near field communication such as Bluetooth(trademark), without employing paper coupons.

2. Prior Art

Merchandise discount coupons are distributed by product manufacturers or retailers by printing them in local or national publications, or are mailed directly to potential customers, or are printed on the packaging of a merchandise so as to entice further purchase of the product by the customer. Furthermore, once the coupons are redeemed by the customer at a retail location, the coupons must be manually processed by the retailer to provide reporting to the coupons issuers, or alternatively the coupons are sent for processing by a clearing house for redemption. The entire process is inefficient and costly. It is estimated that for 50 million discount coupons that are printed, the approximate cost of producing and redeeming these coupons would be approximately $250,000.00.

From the customers' perspective the discount coupons provide an attractive form of savings but the process of clipping and saving these coupons tends to be time-consuming and cumbersome. Furthermore, once these coupons are acquired by the customer, the customer must remember to bring them to the store for redemption. Often times, the customer would not remember particularly to bring the coupons when going to the store for a quick purchase. Additionally, in order to make purchase with merchandise discount coupons, the coupons associated with the desired products must be located among numerous coupons collected by a consumer, and the consumer must ensure that the coupons are to be redeemed before or on their expiry dates. Also, the coupons must be presented to the sales person at the store for scanning or otherwise entering the redemption information into the store's computer.

A number of systems have been developed which address the above described problems for alleviating the tedious nature and high cost of processing discount coupons. The proposed systems eliminate the printed paper coupons by introducing, for example, a single purpose storage card such as a smart card or a magnetic strip card storing the information of the discount coupons. The cards are distributed and used by the consumers. Such storage card are expensive to produce and to issue to the consumers, and the solutions do not provide the coupons issuers with the means to customize their offers based on the consumers' past shopping preferences. Furthermore, the card devices would require the stores to equip with an expensive electronic device terminal for reading them for redemption, and it is difficult for the consumer to update the card devices to acquire new coupons.

### SUMMARY OF THE INVENTION

The present invention overcomes the above deficiencies by employing the consumers' personal wireless devices such as the cell phones for the acquisition and redemption of discount coupons, thereby avoiding the problems of having to issue expensive single purpose storage cards to the consumers.

A cell phone or other wireless device having short range wireless radio such as Bluetooth(trademark) would be employed by the consumer in the system. The short range wireless radio address of the device provides the key value identifier of the consumer in the system, and the registration record of the wireless device based on that value would be maintained at a central computer system. The record would contain a list of discount coupons with the specified discount amount, the product UPC, the expiry date, as well as any other discount coupon property defined by the coupons issuers. The discount coupons would be added to the record by the user by waving the cell phone at advertising panels such that the coupons would be added to the consumers' cell phone account. Alternatively, the coupons may be loaded directly to the wireless cell phone account through a computer programming interface. The interface would allow the coupons issuers to distribute the coupons to the target consumers in the system.

At the retail location, once all of the consumer's purchase items have been scanned into the store's cash register, the consumer would turn on the short range wireless radio of the cell phone to initiate the discovery mode of the cell phone. Next, the cell phone would be waved close to the short range wireless reader terminal provided at the store. The information about the read short range wireless radio address and the list of purchase items would be sent to a central computer which would compare the items purchased to the discount coupons list stored for the given account for the corresponding short range wireless radio address. The computer system would compile a list of discount amount and send it back to the terminal in the store. The total amount of the discount would be displayed on the terminal display of the terminal and more detailed receipt would be printed by the printer of the terminal which may be retained in the cash register for records and accounting purposes. The printout is an optional audit trail and it would be retailer to decide on its usage. If one or more of the purchase items are subject to additional progressive discounts, the system would utilize past purchase history to determine whether the particular item has previously been purchased by the consumer. If this is the case, an increased discount would be calculated.

The central computer system would provide the retailer and the manufacturer with reconciliation functionality associated with each cashier's register, as well as a store-wide reconciliation. The reconciliation data would allow each individual manufacturer who has issued these coupons to reimburse the clearing house properly, as well as to allow the clearing house to reimburse or to be reimbursed by each individual retailer.

### BRIEF DESCRIPTION OF THE DRAWINGS

FIG. 1 is a block diagram of the coupons redemption system at the checkout counter according to the system of the present invention.

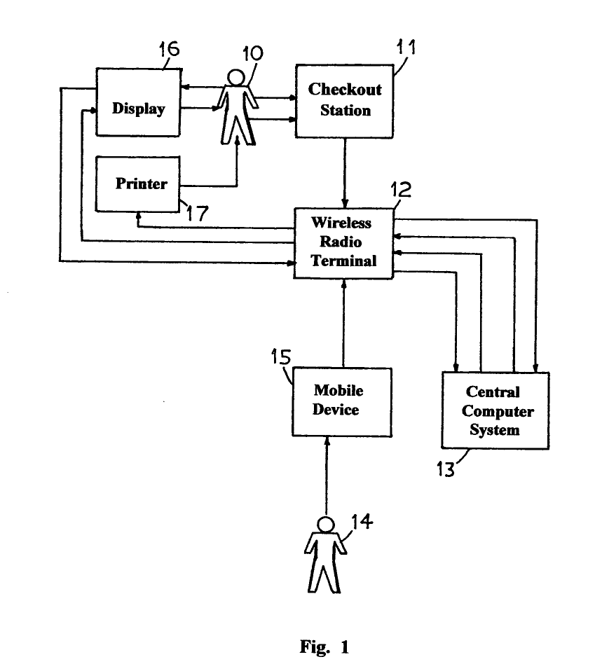

FIG. 2 is a block diagram of the entire system according to the present invention.

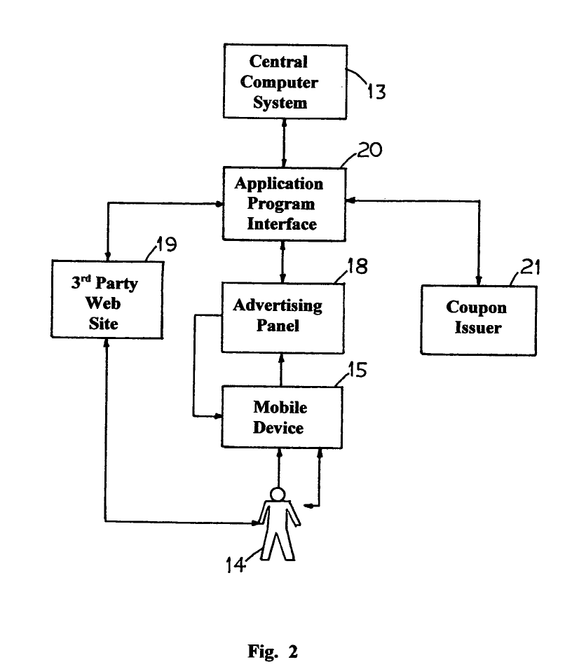

### DETAILED DESCRIPTION OF THE PREFERRED EMBODIMENTS

As shown in the drawings, in the coupons acquisition and redemption system of the present invention, the cashier 10 scans all purchased items to provide the information for a checkout station 11. The UPC of every scanned item is sent to a short range wireless radio terminal 12. After all the items have been scanned, a total cost of the purchased is generated based upon the information provided in the store's network central computer 13. The customer 14 would then locate the wireless device 15 such as the cell phone in close proximity of about 1 to 2 inches of the short range wireless radio terminal 12 associated with the cashier 10 with the wireless device's short range wireless radio turned on and operating in a discovery mode. In response to the discovery mode of the consumer's wireless device 15, the short range wireless radio terminal 12 would initiate a reading function of the short range wireless radio address and the friendly name of the consumer's wireless device 15. Thereafter, the short range wireless radio address, the friendly name and all the scanned UPC are sent to the network central computer system 13. The network central computer system 13 would compare the items purchased to the discount coupons previously registered in system in an initial implementation process, and the information of which is stored for the given account identified by the corresponding short range wireless radio address of the consumer's wireless device 15. The network computer system 13 processes the information and compiles the total amount of discount for the particular purchase and would sent the result back to the display 16 of the short range wireless radio terminal 12, and the cashier 10 upon reading the information would enter the discount amount into the checkout station 11 to be subtracted from the total amount of the transaction. Optionally, the network central computer system 13 would send a detailed receipt to the printer 17 of the short range wireless radio terminal 12. The receipt would be retrieved by the cashier 10, which would be either scanned immediately for entering the information into the checkout station 11 or stored temporarily in the drawer of the cash register at the checkout station 11 for future processing. After having processed the discount amount, the cashier 10 would complete the transaction by pressing a completion button provided on the touch screen of the display 16 to forward a signal over to the network central computer system 13 where the process would commit the logic of the coupon redemption.

In the initial implementation of the discount coupon acquisition, the consumer 14 collects the discount coupons by using the mobile wireless device 15 to contact a coupon issuer such as an advertising panel 18, or a third party web site 19, or via a mass mailing functionality provided by a system Application Program Interface (API) 20, to register for participation in the system. During the registration process, the coupon issuer would request the consumer 14 to provide the International Mobile Equipment Identity (IMEI) number of the wireless device to establish an identity of an account. The consumber 14 would enter the IMEI number into a registration form, and would also specify if mass mailing of discount coupons is allowed and the type of products interested.

The advertisement panel 18 presents a visual information of the coupons that are offered and invites the consumer 14 to activate the short range mobile wireless device 15 and locating it in proximity of up to 150 feet of the advertisement panels 18. The advertisement panels 18 in response to the request from the consumer's wireless device 15 would forward the consumer's short range wireless radio address and friendly name of the wireless device through the Application Program Interface 20 to the central computer system 13. The network central computer system 13 would insert the discount coupons into the account identified by the short range wireless radio address and then send a confirmation back to the advertisement panels 18. Thereafter the advertisement panels 18 would send a text message (SMS) to the consumer's mobile device 15 with the notification information confirming the acceptance of the request.

When interacting with the 3^{rd} party web site 19, the consumer 14 will be requested to enter the IMEI number of the wireless device in order to receive a selected discount coupons. Upon receiving the request, the web site 19 would forward the coupons through the system's application program interface 20 to the network central computer system 13. The network central computer system 13 would insert the selected coupons into the consumer's account identified by the IMEI number and then it would send a confirmation back to the web site 19. Thereafter, the web site 19 would display a notification information to the consumer 14.

The coupon issuer 21 may mass mail coupons to the system via the system application program interface 20. The coupons sent by the network central computer system 13 will be added to the consumer's account based on the preferences set by the consumer during the registration process. After a selected discount coupons have been added into the consumer's account, the network central computer system 13 will notify the consumer 14 via email or short text message (SMS).

Alternatively, the consumer would be provided with a unique activation token string during the initial registration process by using the application program interface 20. The consumer enters the activation token in the consumer's wireless device 15 as the value for the device's Bluetooth(trademark) friendly name. The retail establishment or the advertisement panel 18 reading the consumer's Bluetooth(trademark) address and friendly name would communicate the information to the network central computer system 13 for storing the Bluetooth(trademark) address on the registration record with matched Bluetooth(trademark) friendly name to the issued activation token. The network central computer system 13 would activate the registered wireless device 15 and send an activation notification to be displayed on the screen of the advertisement panel 18, and also send a notation in the form of a text message (SMS) to the consumer's wireless device 15. Optionally, the notation is sent to the consumer's email address provided by the consumer during the initial registration process.

Also, the identity of the consumer's mobile equipment may be extended by an additional wireless identification address in the form of a RFID tag attached to the consumer's mobile wireless device.

While the preferred embodiments of the invention have been described above. It will be recognized and understood that various modifications may be made therein and the appended claims are intended to cover all such modifications which may fall within the spirit and scope of the invention.

What we claim is:

1. A wireless system for discount coupons acquisition and redemption comprising,
a wireless device having short range wireless radio communication and uniquely identified with a mobile equipment identity number,
a network central computer system provided with a memory containing a list of mobile equipment identity numbers of all customers having registered with said network central computer system, a list of available discount coupons for said customers, product UPC number of products related to said discount coupons, expiry date of said discount coupons, and other properties defined by issuers of said discount coupons,
an application program interface in communication with said network central computer system for said customers for maintaining said list of available discount coupons, and for said coupons issuers to add further discount coupons into said list of available discount coupons,
a checkout station located in a retailer and in communication with said network central computer system, said checkout station including a first terminal for entering information relating to products purchased by selected one of said customers and a second communication terminal provided with a reader of said short range wireless radio communication, a printer operative for providing a print out of a purchase by said selected one of said customers, and a touch screen display operative for said selected one of said customers to interface with said network central computer system,
an advertisement panel including a short range wireless radio communication reader and in communication with said network central computer system.

2. A system according to claim 1 wherein said network central computer system is a local computer system located completely in a single retail establishment.

3. A system according to claim 1 wherein said network central computer system is a remote central computer system in communication with a local computer system located in a single retail establishment.

4. A system according to claim 1 wherein said network central computer system includes a plurality of local computer system located in a plurality of separate individual retail establishment.

5. A system according to claim 1 wherein said network central computer system is a remote central computer system in communication with a plurality of local computer systems located in a plurality of separate individual retail establishments.

6. A system according to claim 1 further including a third terminal in communication with said network central computer system for initial registration of said mobile equipment identity of said wireless short range communication radio devices.

7. A system according to claim 5 wherein said local computer systems are provided with a reconciliation means for reconciling a total amount of discount coupons redeemed by a customer purchasing a plurality of products covered by said discount coupons.

8. A system according to claim 7 wherein said reconciliation means is in communication with said network central computer system.

9. A system according to claim 1 wherein said network central computer system contains a list of products previously purchased by said customers.

10. A system according to claim 1 wherein said network central computer system is provided with coupon clearing means for coupon issuers to approve the total monetary amount of redeemed discount coupons submitted for products purchased by said selected one of said customers.

11. A system according to claim 1 wherein said mobile equipment identity is an international mobile equipment identity number of a wireless device of said customers.

12. A system according to claim 1 wherein said mobile equipment identity is a Bluetooth(trademark) radio address of a wireless device of said customers.

13. A system according to claim 12 wherein said advertisement panel identifies said customers by individual Bluetooth(trademark) radio address of said wireless device of said customers, and said advertisement panel personalized an advertising message based on preferences of said customers retrieved from said network central computer system.

14. A system according to claim 13 wherein said network central computer system calculates a total discount amount based on total value of the products purchased.

15. A system according to claim 13 wherein said network central computer system calculates a total discount amount based on parameters defined by said retailer including time of day and day of the week of the purchase and history of previous purchases by said customers.

16. A method of coupon acquisition and redemption wirelessly by a customer comprising,
providing a unique activation token to said customer during a initial registration process by a network central computer system through an application program interface,
said customer entering said activation token into a wireless mobile device as a value of a friendly name of said device, said device having an identifying radio address,
a short range wireless radio reader located at a coupon distribution outlet reading said friendly name and communicating said friendly name together with said radio address of said device to said network central computer system for storing said radio address with matched friendly name to said issued activation token, said network computer system activating said wireless device and sending an activation notification to said coupon distribution outlet, and sending a notification by text message to said wireless device of said customer.

17. A system according to claim 16 wherein said activation notification is sent to a display screen of a first terminal display of a retailer, and said notification is also sent to said customer through an email address provided by said customer during said initial registration process.

18. A system according to claim 12 wherein said mobile equipment identity is extended by additional wireless identification address in the form of a RFID tag attached to a wireless device of said customer.
